(19) United States
(12) Patent Application Publication
(10) Pub. No.: US 2005/0269928 A1
(43) Pub. Date: Dec. 8, 2005

(54) Long life-time field emitter for field emission device and method for fabricating the same

(76) Inventors: Won-Seok Kim, Yongin-si (KR); Jae-Sang Ha, Busan-si (KR); Jeong-Hee Lee, Seongnam-si (KR); Tae-Won Jeong, Seoul (KR); Byung-Yun Kong, Yeosu-si (KR)

Correspondence Address: Robert E. Bushnell, Suite 300, 1522 K Street, N.W., Washington, DC, 20005-1202, US

(21) Appl. No.: 11/141,325

(22) Filed: Jun. 1, 2005

(30) Foreign Application Priority Data
Jun. 3, 2004 (KR) 10-2004-0040313

(51) Int. Cl. H01J 1/00; H01J 1/14; H01J 9/04

(52) U.S. Cl. 313/311; 313/310; 313/495; 445/50; 445/51

(57) ABSTRACT

An emitter for a field emission device (FED) designed to increase durability by interposing an ultraviolet (UV) transmissive resistive layer between a substrate and an emitter and a method for fabricating the same. The method includes depositing a transparent electrode on a transparent substrate, forming a resistive layer by stacking an ultraviolet (UV) transmissive resistive material on the transparent electrode, forming an emitter layer by stacking a carbon nanotube (CNT) on the UV transmissive resistive material, and patterning the emitter layer according to a predetermined emitter pattern.

### CLAIM OF PRIORITY

This application makes reference to, incorporates the same herein, and claims all benefits accruing under 35 U.S.C. §119 from an application entitled LONG LIFE-TIME FIELD EMITTER FOR FIELD EMISSION DEVICE AND METHOD FOR FABRICATING THE SAME filed with the Korean Industrial Property Office on Jun. 3, 2004 and there duly assigned Serial No. 10-2004-0040313.

### BACKGROUND OF THE INVENTION

1. Field of the Invention

The present invention relates to a durable emitter for a field emission device (FED), and a method for fabricating the same, and more particularly, to an emitter for a FED designed to increase the life span by interposing an ultraviolet (UV) transmissive resistive layer between a substrate and an emitter and a method for fabricating the same.

2. Description of the Related Art

As display technology advances, a flat panel displays are becoming more widely used than traditional cathode ray tube (CRT) displays. A representative example of the flat panel display includes a liquid crystal display (LCD) and a plasma display panel (PDP). Research into FEDs using the field emitter using a metal tip is now under way. FEDs are expected to be promising next-generation displays offering high brightness and wide field-of-view comparable to CRTs with a thin and lightweight design comparable to LCDs.

FEDs use physical principles similar to those in CRTs. That is, electrons emitted by a cathode are accelerated and collide with a phosphor-coated anode to excite a phosphor that then emits a specific color of light. However, the difference between FEDs and CRTs is that a FED uses a cold-cathode electron emission source and a CRT does not. Although a metal tip was mainly used as an electron emission source (emitter) of a FED in the initial phase of development, ongoing research is being conducted to develop an affordable emitter that uses carbon nanotubes (CNTs) instead of metal tips to provide excellent field emission characteristics.

However, CNT emitters for FEDs have their own problems. CNTs are often plagued by non-uniformity in length, conductivity and resistance at lower portions of the CNT. Therefore, what is needed is a design for an FED that overcomes this problem while being easy to make. Since single-walled CNTs (SWNTs) generally have better electrical properties than multi-walled CNT (MWNT) structures, what is needed is a method of making SWNTs and a method of making an FED incorporating the SWNT.

### SUMMARY OF THE INVENTION

It is therefore an object of the present invention to provide an improved design for a SWNT and an FED incorporating the SWNT.

It is also an object of the present invention to provide a design for an FED using SWNTs that is easy to make, that uses single-walled CNTs and has superior electrical uniformity.

It is yet another object of the present invention to provide a design for an FED that uses a back exposure technique to form single walled CNT emitters.

It is still an object of the present invention to provide a carbon nanotube (CNT) emitter for a field emission device (FED) designed to offer more uniform current density, longer life-time, and higher brightness.

It is also an object of the present invention to provide a method of making the novel FED that utilizes back exposure technique.

These and other objects can be achieved by a method of fabricating an emitter for a diode-type FED that includes depositing a transparent electrode on a transparent substrate, forming a UV transmissive resistive layer by stacking ultraviolet (UV) transmissive resistive material on the transparent electrode, forming an emitter layer by stacking a carbon nanotube (CNT) on the UV transmissive resistive layer, and patterning the emitter layer according to a predetermined emitter pattern. The resistive layer is formed by applying a UV transmissive resistive material in paste form on a transparent electrode and sintering the paste to solidify the paste.

The UV transmissive resistive material has a resistivity greater than 10 Ω·m and contains at least one of Cr₂O₃, Na₂O₂, SO₂, CaO, Sc₂O₃, TiO₂, VO₂, V₂O₅, Mn₃O₄, Fe₂O₃, CoO, Co₃O₄, Cu₂O, CuO, ZnO, SrO, SrO₂, Y₂O₃, ZrO₂, PdO, DcO, In₂O₃, BaO, La₂O₃, CeO₂, Pr₂O₃, Nd₂O₃, Sm₂O₃, Gd₂O₃, Tb₂O₃, Dy₂O₃, Er₂O₃, Yb₂O₃, Ta₂O₅, WO₃, PbO, UO₂, and U₃O₅. Preferably, the UV transmissive resistive material contains Cr₂O₃.

Alternatively, a method of making an emitter for a triode-type FED includes depositing a transparent electrode on a transparent substrate, forming insulating layers on opposite sides of the top surface of the transparent electrode, forming a gate electrode on top of the insulating layer, and forming a resistive layer made of an ultraviolet (UV) transmissive resistive material and a carbon nanotube (CNT) emitter layer on the transparent electrode and between the opposing insulating layers. Sidewalls of the resistive layer and the emitter layer can be separated from sidewalls of the opposing insulating layers by a predetermined distance.

The forming of the UV transmissive resistive layer and the emitter layer includes coating a photoresist to cover the top surfaces of the gate electrodes and the opposing sidewalls of the insulating layers and the gate electrodes, forming the resistive layer by stacking a UV transmissive resistive material on the transparent electrode between the opposing insulating layers, forming an emitter layer by stacking a CNT on the resistive layer, and patterning the emitter layer according to a predetermined emitter pattern using a photolithographic process.

According to another aspect of the present invention, there is provided an FED including the emitter for a triode-type FED fabricated according to the former method, a second transparent substrate that is located opposite and spaced apart from the emitter of the FED by a predetermined distance, a second transparent electrode formed on a surface of the second transparent substrate that faces the emitter, and a phosphor layer coated on a surface of the second transparent electrode and facing the emitter.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a field emission device (FED) using carbon nanotubes (CNTs);

FIGS. 2A-2E are cross-sectional views illustrating a method of fabricating an emitter for a diode-type FED according to a first embodiment of the present invention;

FIGS. 3A-3G are cross-sectional views illustrating a method of fabricating an emitter for a triode-type FED according to a second embodiment of the present invention;

FIG. 4 is a graph illustrating a comparison between current-voltage (I-V) characteristics for CNT emitters with and without a resistive layer;

FIG. 5 is a graph illustrating a comparison between life spans of emitters having and not having a resistive layer is used;

FIGS. 6A and 6B are photographs illustrating light emissions at an anode of an FED made with a CNT emitter for without and with a resistive layer respectively; and

FIG. 7 is a cross-sectional view of an undergate-type emitter for a FED according to a third embodiment of the present invention.

### DETAILED DESCRIPTION OF THE INVENTION

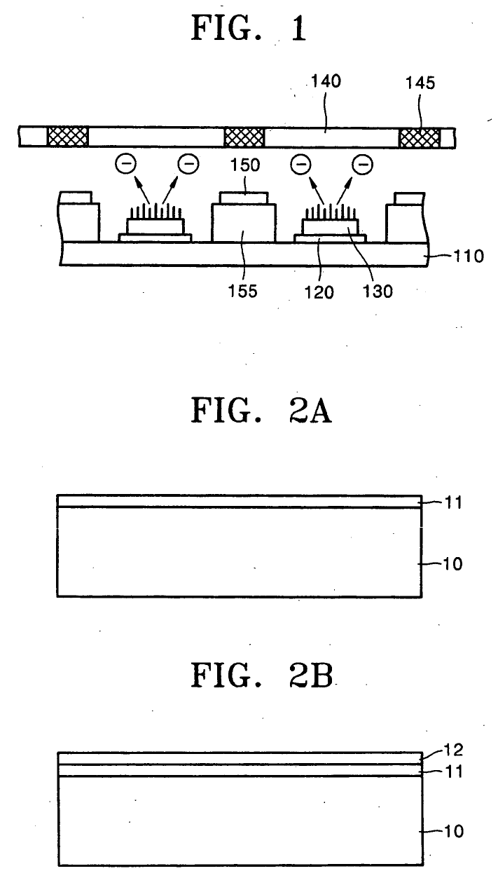

Turning now to the figures, FIG. 1 illustrates a triode type field emission device (FED) using carbon nanotubes (CNTs). Referring to FIG. 1, an emitter 130 made out of CNTs is formed on a cathode 120 that overlies a substrate 110. Opposing the emitter 130 is a phosphor layer 140 with black matrix portions 145 separating different pixels. When a voltages are applied to a gate electrode 150 and the cathode 120, electrons are released from a tip of the thin thread-like CNT. These electrons travel to phosphor 140 and cause visible light to be emitted from phosphor 140.

In a FED using CNTs an emitters, there are two methods for fabricating the emitter. The first method is to apply a photosensitive paste containing a CNT over a substrate and pattern the paste using photolithography. The second method is to directly grow CNTs on a substrate using chemical vapor deposition (CVD). An overcurrent condition can sometimes occur in a particular CNT emitter fabricated by one of the above methods due to non-uniformity in CNT length, conductivity, and resistance at a lower portion of the CNT. This abnormal electron emission results in decreased CNT life span, uneven overall product quality, and lower brightness.

To improve these non-uniformity problems, a proposed solution includes interposing an amorphous silicon (a-Si) resistive layer between the substrate and the CNT emitter. More specifically, a-Si is deposited over the substrate using CVD to form a resistive layer and then the CNT is grown on the resistive layer by CVD to form an emitter. The resistive layer causes a certain voltage drop at the lower portion of a CNT, thus making current applied to individual CNTs uniform.

However, a photolithographic process using back exposure cannot be used to pattern the CNT because the a-Si is not transparent to UV exposure light. Thus, since the first method that applies a paste containing CNTs to the substrate and patterns the same cannot be used to fabricate a CNT emitter when a-Si is used, the CNT emitter must be fabricated by the second method of growing CNTs using CVD. The CVD method allows for only the growth of multi-walled CNT (MWNT) having a large diameter, as CVD cannot be used to grow SWNTs. This is important since a field enhancement effect is proportional to a CNT length and inversely proportional to a CNT diameter and a single-walled CNT (SWNT) having a small diameter provides an emitter with superior electrical characteristics over that of the MWNT. Therefore, use of a-Si for the resistive layer essentially precludes the ability to later form a CNT emitter structure with uniform electrical characteristics. Also, the high-temperature CVD suffers from a restriction in material that can be used for the substrate and the electrode. CVD further does not have high uniformity in growth from emitter to emitter. Still further, CVD is expensive in a manufacturing environment. Therefore, to form SWNTs on a resistive layer, there is a need for using resistive material that is transparent to UV exposure light so CNT paste can be applied and back exposed.

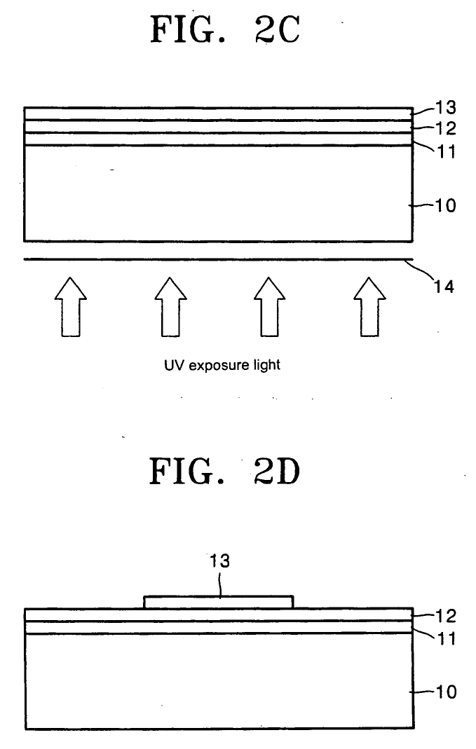

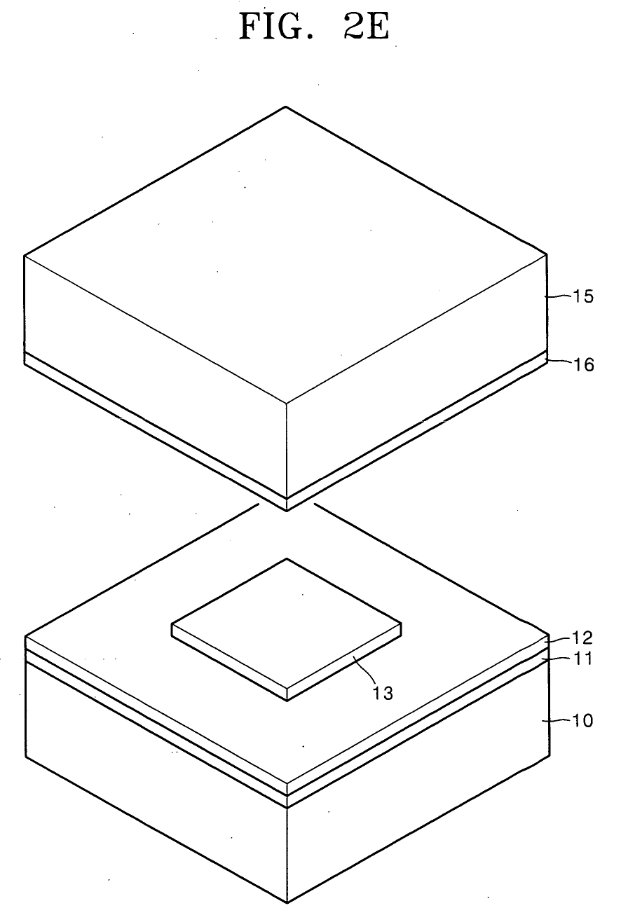

Turning now to FIGS. 2A through 2E, FIGS. 2A through 2E illustrate a method of making a diode-type FED according to a first embodiment of the present invention. Referring to FIG. 2A, a transparent electrode 11 such as indium tin oxide (ITO) is first deposited over a transparent substrate 10 such as glass. Turning now to FIG. 2B, a resistive layer 12 is then formed on the transparent electrode 11. The resistive layer 12 is used to provide a uniform current to the CNT. Instead of using non-UV transmissive amorphous silicon (a-Si) for the resistive layer, an ultraviolet (UV) transmissive resistive material is used in the present invention to allow for a patterning process using back exposure. The resistive material has a resistivity greater than 10 Ω·m, and is preferably in the range of 10² Ω·m to 10³ Ω·m, in order to obtain a sufficient voltage drop. Examples of the material satisfying these requirements for the resistive layer 12 include Cr₂O₃, Na₂O₂, SO₂, CaO, Sc₂O₃, TiO₂, VO₂, V₂O₅, Mn₃O₄, Fe₂O₃, CoO, Co₃O₄, CU₂O, CuO, ZnO, SrO, SrO₂, Y₂O₃, ZrO₂, PdO, DcO, In₂O₃, BaO, La₂O₃, CeO₂, Pr₂O₃, Nd₂O₃, Sm₂O₃, Gd₂O₃, Tb₂O₃, Dy₂O₃, Er₂O₃, Yb₂O₃, Ta₂O₅, WO₃, PbO, UO₂, and U₃O₅. Preferably, Cr₂O₃ is used as the resistive material.

A method of forming the resistive layer 12 includes making at least one of the UV transmissive resistive materials in a paste form, applying the UV transmissive resistive material in a paste form on the transparent electrode 11, and sintering the paste to solidify the paste. Alternatively, the resistive layer 12 can be formed by depositing the UV transmissive resistive material in the form of a thin film on the transparent electrode 11 using a commonly used deposition technique.

Next, turning now to FIG. 2C, an emitter layer 13 is formed by stacking a CNT on the resistive layer 12. The CNT can be stacked on the resistive layer I2 by applying a CNT paste on the resistive layer 12 or by growing the CNT on the resistive layer 12 using chemical vapor deposition (CVD). However, since the CVD growth requires the use of a multi-walled CNT (MWNT) having a large diameter as described above, application of a CNT paste is more desirable for the present invention. When the CNT paste is applied on the resistive layer 12, both single-walled CNT (SWNT) and MWNT can be made, but the SWNT having a small diameter is preferred.

After the emitter layer 13 has been formed on the resistive layer 12, the emitter layer 13 is patterned according to a desired pattern. To achieve this, as illustrated in FIG. 2C, a mask 14 having the desired pattern is aligned under the transparent substrate 10 and is then irradiated with UV light from below. The transparent substrate 10 is irradiated with the UV light through the mask 14 causing portions of the emitter layer 13 to be exposed to the UV light according to the pattern of the mask 14. After the emitter layer 13 is cleaned with ethanol, an emitter for a FED is completed as illustrated in FIG. 2D.

Turning now to FIG. 2E, the completed diode-type FED includes the emitter completed using the above method, a second transparent substrate 15 located opposite and spaced apart from the emitter layer 13 by a predetermined distance, a second transparent electrode 16 formed on an inner surface of the second transparent substrate 15, and a phosphor layer (not illustrated) coated on a surface of the second transparent electrode 16 facing the emitter layer 13. The second transparent electrode 16 can be made of ITO, and the second transparent substrate 15 can be made of glass.

The operation of the FED configured above as in FIG. 2E will now be described. First, negative and positive voltages are applied to first and second transparent electrodes 11 and 16, respectively. Electrons are emitted from the emitter layer 13 made of the CNT and propagate toward the second transparent electrode 16 held to a positive voltage. In this case, electrons collide with the phosphor layer coated on the second transparent electrode 16 and excite the phosphor layer to emit a specific color of light.

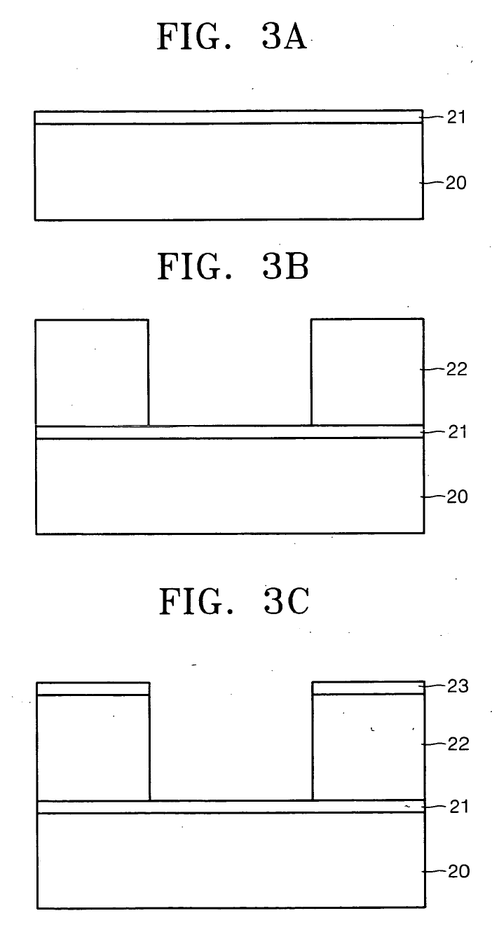

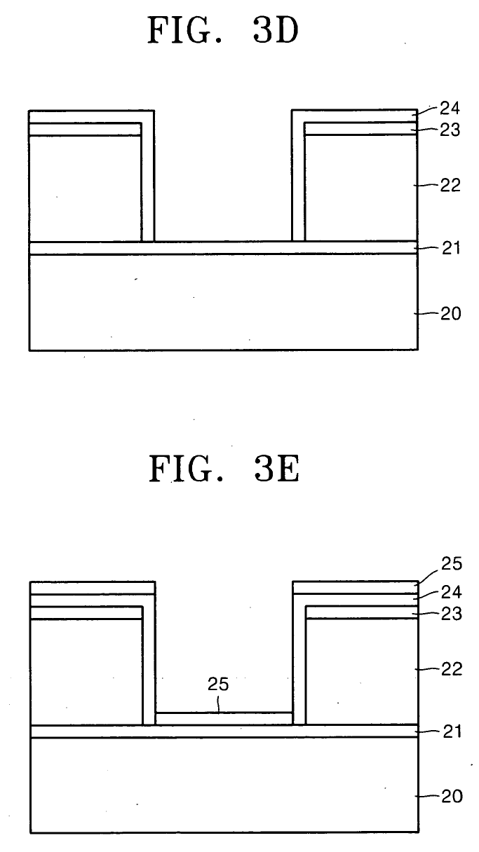

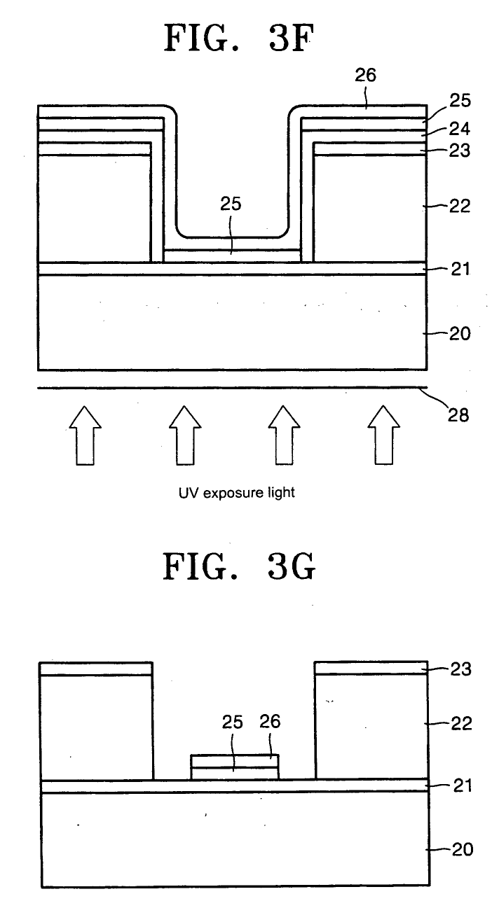

Turning now to FIGS. 3A through 3G, FIGS. 3A-3G are cross-sectional views illustrating a method of fabricating an emitter for a triode-type FED according to a second embodiment of the present invention. Unlike the diode-type FED of FIGS. 2A through 2E, the triode-type FED includes a gate electrode.

Turning now to FIG. 3A, a transparent electrode 21 preferably made of ITO is deposited on a transparent substrate 20 preferably made of glass. Turning now to FIG. 3B, insulating layers 22 are formed at opposite ends of the top surface of the transparent electrode 21. A middle portion of the top surface of the transparent electrode 21 between the insulating layers 22 is reserved to form a resistive layer and an emitter layer during a subsequent processes. The insulating layers 22 are formed by applying a paste containing an insulating material such as SiO₂ or PbO on the transparent electrode 21 and then solidifying the same through a sintering process. Subsequently, as illustrated in FIG. 3C, a conductive metal such as chrome (Cr) is sputtered to form a gate electrodes 23 on the insulating layers 22.

Turning now to FIG. 3D, photoresist 24 is coated to cover the top surfaces of the gate electrodes 23 and the opposing sidewalls of the insulating layers 22 and the opposing sidewalls of the gate electrodes 23. The purpose of the photoresist 24 formed on the sidewalls of the insulating layers 22 and the gate electrodes 23 is to separate the sidewalls of the insulating layers 22 from a resistive layer and from an emitter layer to be later formed between the insulating layers 22 and the gate electrodes 23.

Turning now to FIG. 3E, a resistive layer 25 is then formed by stacking a UV transmissive resistive material on the transparent electrode 21 between the opposing insulating layers 22 and between the photoresist 24. As with the resistive layer 12 in FIGS. 2A through 2E, the resistive material used in the resistive layer 25 in FIGS. 3E through 3G has resistivity greater than 10 Ω·m and preferably in the range of 10² Ω·m to 10³ Ω·m. Examples of the material satisfying this requirement include Cr₂O₃, Na₂O₂, SO₂, CaO, Sc₂O₃, TiO₂, VO₂, V₂O₅, Mn₃O₄, Fe₂O₃, CoO, Co₃O₄, Cu₂O, CuO, ZnO, SrO, SrO₂, Y₂O₃, ZrO₂, PdO, DcO, In₂O₃, BaO, La₂O₃, CeO₂, Pr₂O₃, Nd₂O₃, Sm₂O₃, Gd₂O₃, Tb₂O₃, Dy₂O₃, Er₂O₃, Yb₂O₃, Ta₂O₅, WO₃, PbO, UO₂, and U₃O₅. In this second embodiment, Cr₂O₃ is used as the UV transmissive resistive material. Like the first embodiment, the UV transmissive resistive material is applied on the transparent electrode 21 in a paste form and is subsequently sintered to solidify using a common method. Alternatively, the UV transmissive resistive material can be deposited in the form of a thin film on the transparent electrode 21 using a commonly used deposition technique.

Turning now to FIG. 3F, an emitter layer 26 is formed by stacking CNTs on the photoresist 24 and on the resistive layer 25. As described above, the CNTs can be stacked by applying the CNTs in a paste form or by growing the CNTs by CVD. However, application of the CNT paste is more desirable in the second embodiment as well since the CVD growth is not limited to the formation of MWNTs. When the CNT paste is applied on the resistive layer 25, both SWNT and MWNT can be produced, but preferably the SWNT is produced because of its superior uniformity of electrical characteristics brought about by its small diameter.

After the application of the emitter layer 26, the emitter layer 26 is then patterned according to a predetermined emitter pattern using photolithography. To accomplish this, as illustrated in FIG. 3F, a mask 28 is aligned under the transparent substrate 20 that is then irradiated with UV light from the back side. A pattern corresponding to the desired emitter pattern is present on the mask 28. The emitter layer 26 is exposed and developed. Then, the patterned emitter layer 26 is cleaned with ethanol. At this time, the photoresist 24 as well as unnecessary portions of the UV transmissive resistive material and CNTs overlying the photoresist 24 are removed together. Thus, an emitter for a triode-type FED as illustrated in FIG. 3G is completed.

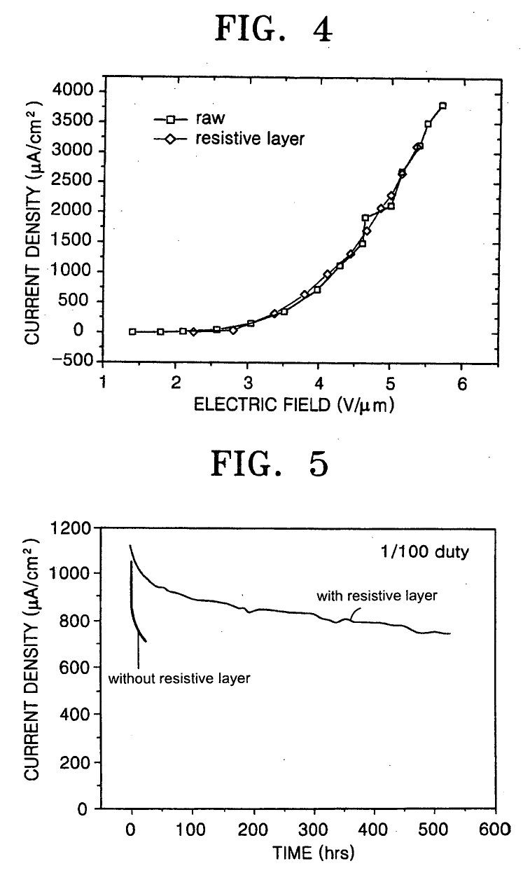

Turning now to FIG. 4, FIG. 4 is a graph illustrating a comparison of current-voltage (I-V) characteristics for CNT emitters with and without the presence of a resistive layer. Square-shaped dots on the graph indicate the I-V characteristics measured when no resistive layer is used (raw) while diamond-shaped dots indicate those measured when a resistive layer is used. As is evident by FIG. 4, there is almost no loss in current transferred to a CNT emitter when the resistive layer is used. Thus, use of the resistive layer does not decrease field emission characteristics and thus does not decrease brightness. While a voltage drop caused by the presence of the resistive layer can reduce variation between currents applied to individual CNTs, the voltage drop is not large enough to significantly decrease an overall average current. To avoid an excessive voltage drop, the resistive layer must have a thickness of about 150 nm.

Turning now to FIG. 5, FIG. 5 is a graph illustrating a comparison between life spans of emitters with and without the presence of a resistive layer. For comparison, the density of current flowing through a CNT emitter is measured at an electric field of 4.2 V/μm. As is evident by FIG. 5, the current density drops to about one half of its initial value after about 50 hours and 500 hours for emitters without a resistive layer and with a resistive layer, respectively. Thus, a CNT emitter according to the present invention has a much longer life span than a CNT emitter without the resistive layer.

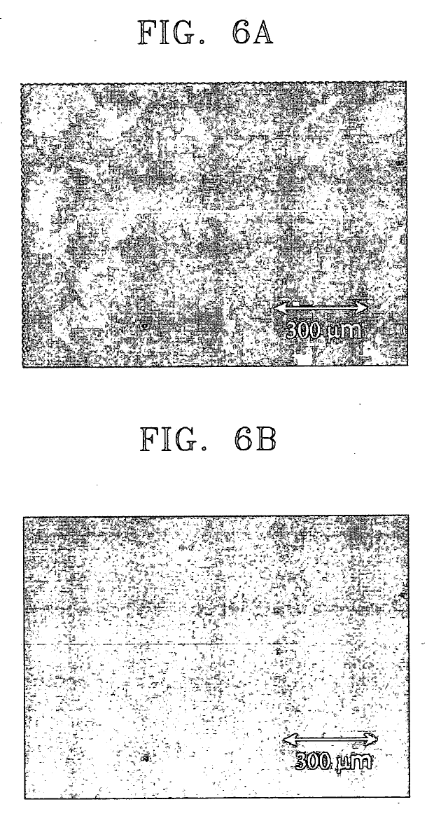

Turning now to FIGS. 6A and 6B, FIGS. 6A and 6B are photographs illustrating light emissions at an anode for emitters without and with a resistive layer, respectively. As is evident by FIG. 6A, light emission is non-uniform since electrons are emitted only from a specific emitter when no resistive layer is used. As illustrated in FIG. 6B, the anode light emission is uniform since electrons are uniformly released from individual emitters when resistive layer is present.

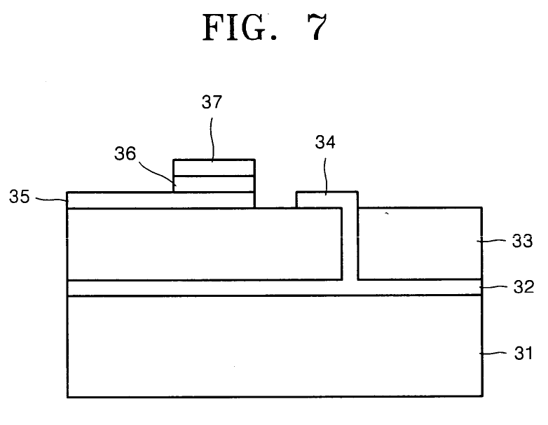

While FIG. 3G illustrates the emitter for a triode-type FED with a gate overlying a CNT emitter, an undergate-type emitter for a FED can instead be formed as illustrated in FIG. 7. Referring now to FIG. 7, a transparent electrode 32 and an insulating layer 33 are sequentially formed on top of a transparent substrate 31, and a gate 34 penetrates the insulating layer 33 and is connected to the transparent electrode 32. An electrode 35 for an emitter is formed on the insulating layer 33, and a resistive layer 36 and a CNT emitter 37 are sequentially formed on top of the electrode 35. In FIG. 7, the CNT emitter 37 and the gate 34 are located opposite each other. The resistive layer 36 is also made of a UV transmissive resistive material. In the undergate structure of FIG. 7, it is possible to fabricate an SWNT emitter through a back exposure technique and achieve the same effect as described above.

The present invention allows a resistive layer underlying a CNT emitter to disperse current uniformly across the CNT emitter, thus increasing the life span of the product, improving current distribution uniformity, and improving brightness. The present invention also makes it possible to use a resistive layer that can be used in fabricating a CNT emitter through a back exposure technique and during a high temperature process. Thus, the present invention allows for the use of a SWNT with large field enhancement effect, thus providing a higher quality CNT emitter

While the present invention has been particularly illustrated and described with reference to exemplary embodiments thereof, it will be understood by those of ordinary skill in the art that various changes in form and details may be made therein without departing from the spirit and scope of the present invention as defined by the following claims.

1. A method of fabricating an emitter, comprising:
depositing a transparent electrode on a transparent substrate;
stacking an ultraviolet (UV) transmissive resistive layer on the transparent electrode; and
forming a carbon nanotube (CNT) emitter layer by stacking a carbon nanotube (CNT) emitter material on the UV transmissive resistive layer and patterning the CNT emitter material.

2. The method of claim 1, stacking the UV transmissive resistive layer comprises:
applying a UV transmissive resistive paste onto the transparent electrode; and
sintering the UV transmissive resistive paste to solidify the UV transmissive resistive paste into the UV transmissive resistive layer.

3. The method of claim 2, the UV transmissive resistive layer having a resistivity greater than 10 Ω·m.

4. The method of claim 3, the UV transmissive resistive layer comprises at least one material selected from the group consisting of Cr₂O₃, Na₂O₂, SO₂, CaO, Sc₂O₃, TiO₂, VO₂, V₂O₅, Mn₃O₄, Fe₂O₃, CoO, Co₃O₄, Cu₂O, CuO, ZnO, SrO, SrO₂, Y₂O₃, ZrO₂, PdO, DcO, In₂O₃, BaO, La₂O₃, CeO₂, Pr₂O₃, Nd₂O₃, Sm₂O₃, Gd₂O₃, Tb₂O₃, Dy₂O₃, Er₂O₃, Yb₂O₃, Ta₂O₅, WO₃, PbO, UO₂, and U₃O₅.

5. The method of claim 3, the UV transmissive resistive material comprises Cr₂O₃

6. The method of claim 1, the stacking of the CNT emitter material comprises applying a CNT paste on the UV transmissive resistive layer.

7. The method of claim 1, the stacking the UV transmissive resistive layer comprises depositing a UV transmissive resistive material on the transparent electrode in the form of a thin film.

8. The method of claim 1, the patterning the CNT emitter material comprises:
aligning a mask under the transparent substrate, the mask having a pattern corresponding to the CNT emitter layer;
irradiating the mask and the transparent substrate with UV light; and
cleaning the emitter layer irradiated with the UV light.

9. The method of claim 1, the stacking of the CNT emitter material comprises growing the CNT emitter layer using chemical vapor deposition (CVD).

10. A field emission device (FED) comprising an emitter that comprises:
a transparent substrate;
a transparent electrode arranged on the transparent substrate;
an ultraviolet (UV) transmissive resistive layer arranged on the transparent electrode; and
a patterned carbon nanotube (CNT) emitter layer arranged on the UV transmissive resistive layer.

11. The FED of claim 10, further comprising:
a second transparent substrate arranged opposite and spaced apart from the emitter;
a second transparent electrode arranged on a side of the second transparent substrate that faces the emitter; and
a phosphor layer arranged on the second transparent electrode.

12. A method of fabricating an emitter, comprising:
depositing a transparent electrode on a transparent substrate;
forming insulating layers opposing one another on opposite sides of a top surface of the transparent electrode;
forming a gate electrodes on tops of the insulating layers;
forming a resistive layer comprising an ultraviolet (UV) transmissive resistive material on the transparent electrode between the opposing insulating layers;
forming a carbon nanotube (CNT) emitter layer on the resistive layer and between the opposing insulating layers.

13. The method of claim 12, sidewalls of each of the resistive layer and the emitter layer are separated from sidewalls of the opposing insulating layers by a predetermined distance.

14. The method of claim 13, the forming the resistive layer and the forming the emitter layer comprises:
coating a photoresist to cover top surfaces of the gate electrodes and covering opposing sidewalls of the insulating layers and the gate electrodes;
forming the resistive layer by stacking a UV transmissive resistive material on the transparent electrode between the opposing insulating layers;
forming the emitter layer by stacking CNT material on the resistive layer; and
patterning the emitter layer using a photolithographic process.

15. The method of claim 14, the forming of the emitter layer being comprised of applying a CNT paste on the resistive layer.

16. The method of claim 14, the patterning the emitter layer using a photolithographic process comprises:
aligning a mask having a pattern corresponding to an emitter pattern under the transparent substrate;
irradiating the mask and the transparent substrate with UV light; and
performing a cleaning process to remove the photoresist and unnecessary portions of the UV transmissive resistive material and CNTs.

17. The method of claim 14, the UV transmissive resistive material having resistivity greater than 10 Ω·m.

18. The method of claim 17, the UV transmissive resistive material comprises at least one material selected from the group consisting of Cr₂O₃, Na₂O₂, SO₂, CaO, Sc₂O₃, TiO₂, VO₂, V₂O₅, Mn₃O₄, Fe₂O₃, CoO, Co₃O₄, Cu₂O, CuO, ZnO, SrO, SrO₂, Y₂O₃, ZrO₂, PdO, DcO, In₂O₃, BaO, La₂O₃, CeO₂, Pr₂O₃, Nd₂O₃, Sm₂O₃, Gd₂O₃, Tb₂O₃, Dy₂O₃, Er₂O₃, Yb₂O₃, Ta₂O₅, WO₃, PbO, UO₂, and U₃O₅.

19. The method of claim 17, the UV transmissive resistive material comprises Cr₂O₃.

20. A field emission device emitter fabricated according to a process comprising:
depositing a transparent electrode on a transparent substrate;
forming insulating layers opposing one another on opposite sides of a top surface of the transparent electrode;
forming a gate electrodes on tops of the insulating layers;
forming a resistive layer comprising an ultraviolet (UV) transmissive resistive material on the transparent electrode between the opposing insulating layers;
forming a carbon nanotube (CNT) emitter layer on the resistive layer and between the opposing insulating layers.
